(19) United States
(12) Patent Application Publication
(10) Pub. No.: US 2009/0217191 A1
(43) Pub. Date: Aug. 27, 2009

(54) INPUT UNIT AND CONTROL METHOD THEREOF

(76) Inventors: Yun Sup SHIN, Seoul (KR); Yung Woo Jung, Seoul (KR); Young Hwan Joo, Seoul (KR)

Correspondence Address: BIRCH STEWART KOLASCH & BIRCH, PO BOX 747, FALLS CHURCH, VA, 22040-0747, US

(21) Appl. No.: 12/364,186

(22) Filed: Feb. 2, 2009

(30) Foreign Application Priority Data
Feb. 5, 2008 (KR) 10-2008-0011494
Jun. 2, 2008 (KR) 10-2008-0051472
Jul. 16, 2008 (KR) 10-2008-0069314

(51) Int. Cl. G06F 3/048

(52) U.S. Cl. 715/773

(57) ABSTRACT

Provided are an input unit and a control method thereof. According to an embodiment of the input unit and the control method thereof, relationship information between the end of an input member and the end of the shadow of the input member, generated by a light source, are recognized through image processing, and is used to detect if an input is made by the input member.

### CROSS-REFERENCE TO RELATED APPLICATIONS

The present application claims priority under 35 U.S.C. §119 and 35 U.S.C. §365 to Korean Patent Application Nos. 10-2008-0011494 (filed on Feb. 5, 2008), 10-2008-0051472 (filed on Jun. 2, 2008) and 10-2008-0069314 (filed on Jul. 16, 2008), which are hereby incorporated by reference in their entireties.

### BACKGROUND

The present disclosure relates to a virtual optical input unit and a control method thereof.

With recent development of semiconductor technology, information communication apparatus has made much progress. Also, due to an information transmitting method of the information communication apparatus, an intuitive and efficient information transmitting method through characters and position information has increased in related art information communication apparatuses that have depended on simple voice signal transmissions.

However, since an input unit and an output unit of the information communication apparatus should be directly manipulated or recognized by a user, there is a limit in miniaturization and mobility.

Examples of an input unit of a conventional information communication apparatus include a microphone for voice signals, a keyboard for inputting a specific key, and a mouse for inputting position input information.

Particularly, the keyboard and the mouse are useful input units for efficiently inputting a character or position information. However, since these units are poor in portability and mobility, substitutions for such units are under development.

As the substitution units, a touch screen, a touchpad, a pointing stick, and a simplified keyboard arrangement are being studied, but these units have limitations in operability and recognition.

### SUMMARY

Embodiments provide an input unit which allows miniaturization of a structure and low power consumption so that it can be mounted inside a mobile communication apparatus, and which is not restricted to being used on a flat surface. Embodiments also provide a control method of such input unit.

Embodiments also provide an input unit and a control method thereof, which address the limitations and disadvantages associated with the related art.

Furthermore, embodiments provide a mobile terminal or other portable device including an input unit that allows a user input using shadow information associated with the user input.

In one embodiment, a method for controlling an input unit includes: forming an input pattern; capturing an image of an input member on the input pattern; calculating positions related with a portion of the input member and a portion of a shadow thereof, respectively, from the captured image; judging whether the input member contacts or not using information of the calculated positions; and executing a command corresponding to a contact point.

In another embodiment, a method for controlling an input unit includes: forming an input pattern; capturing an image of an input member on the input pattern; calculating a position related with a portion of the input member from the captured image; setting a shadow searching region using information of the calculated position; detecting a position related with a portion of a shadow from the set shadow searching region; judging whether the portion of the input member contacts or not using information of the detected position; and executing a command corresponding to a contact point.

In further another embodiment, an input unit includes: an input pattern generator generating an input pattern; an image receiver capturing the input pattern generated by the input pattern generator, a portion of an input member, and a shadow image corresponding to the portion of the input member; an image processor detecting positions related with the portion of the input member and the portion of the shadow image, respectively, from an image received by the image receiver, and executing a command corresponding to a contact point in the portion of the input member; and a controller controlling the image processor to execute the command corresponding to the contact point when the portion of the input member contacts the input pattern.

In still further another embodiment, a mobile device includes: a wireless communication unit performing wireless communication with a wireless communication system or another device; an input unit detecting whether a position related with a portion of an input member and a position related with a portion of a shadow of the input member contact or not to receive a user's input; a display displaying information; a memory storing an input pattern and a corresponding command; and a controller controlling operations of the above elements.

According to the present disclosure, a miniaturized input unit can be realized.

Also, according to the present disclosure, the number of parts used inside the input unit can be minimized, so that an input unit of low power consumption can be realized.

Also, according to the present invention, character inputting with excellent operability and convenience can be realized.

Also, according to the present invention, since the size of an input space is not limited, the input space can be variously used.

Also, since low power consumption and miniaturization are possible, an effective character input method of a mobile information communication apparatus can be developed.

According to an embodiment, the invention provides a method for controlling an input unit, the method comprising: forming an input pattern; capturing an image of an input member over the input pattern; first determining relationship information between a portion of the input member and a portion of a shadow of the input member using the captured image; second determining whether the input member falls in a contact range of the input pattern based on the relationship information; and executing a command based on the second determination result.

According to another embodiment, the invention provides a method for controlling an input unit including a light generation unit and a light receiving unit, the method comprising: projecting an input pattern using the light generation unit; receiving an image and a shadow of an input member over the input pattern using the light receiving unit; selectively switching at least one of the light generation unit and the light receiving unit based on a mode of the input unit; determining whether the input member falls in a contact range of the input pattern using information of the received image and shadow of the input member; and performing an operation based on the determination result.

According to another embodiment, the invention provides an input unit comprising: a pattern generator configured to project an input pattern onto a surface; an image receiver configured to capture an image of an input member over the input pattern; and an image processor configured to first determine relationship information between a portion of the input member and a portion of a shadow of the input member using the captured image, and to second determine whether the input member falls in a contact range of the input pattern based on the relationship information, whereby a command based on the second determination result can be executed.

According to another embodiment, the invention provides an input unit comprising: at least one light generation unit configured to project an input pattern onto a surface; a light receiving unit configured to receive an image and a shadow of an input member over the input pattern; a switch configured to selectively switch at least one of the light generation unit and the light receiving unit based on a mode of the input unit; and an image processor configured to determine whether the input member falls in a contact range of the input pattern using information of the received image and shadow of the input member, whereby an operation based on the determination result can be performed.

According to another embodiment, the invention provides a mobile device comprising: a wireless communication unit configured to perform wireless communication with a wireless communication system or another device; an input unit configured to receive an input, and including a pattern generator configured to project an input pattern onto a surface, an image receiver configured to capture an image of an input member over the input pattern, and an image processor configured to determine relationship information between a portion of the input member and a portion of a shadow of the input member using the captured image, to determine whether the input member falls in a contact range of the input pattern based on the relationship information, and to decide if the input is made based on these determinations; a display unit configured to display information including the input received by the input unit; and a storage unit configured to store the input pattern.

The details of one or more embodiments are set forth in the accompanying drawings and the description below. Other features will be apparent from the description and drawings, and from the claims.

### BRIEF DESCRIPTION OF THE DRAWINGS

FIGS. 1A and 1B are a front view and a side view of an input unit, respectively, according to an embodiment.

FIG. 2 is a block diagram of an input unit according to an embodiment.

FIGS. 3A and 3B are schematic views illustrating different examples of the construction of an input pattern generator according to an embodiment.

FIGS. 4A and 4B are views illustrating methods of judging whether an input is made according to an embodiment.

FIG. 5 is a view explaining a method of measuring the positions of an input member and a shadow of the input member using a more simplified method according to an embodiment.

FIGS. 6A and 6B are views illustrating a process of correcting a captured image to convert the image into an inversely operated and normalized image in order to more accurately calculate which command has been executed for a contact point according to an embodiment.

FIG. 7 is a view illustrating examples of different stages of an input unit according to an embodiment.

FIGS. 8A and 8B are views illustrating a portable terminal having an input unit according to an embodiment.

FIG. 9 is a block diagram of a mobile device according to an embodiment.

FIG. 10 is a block diagram of a CDMA wireless communication system to which the mobile device of FIG. 9 can be applied.

### DETAILED DESCRIPTION OF THE EMBODIMENTS

Reference will now be made in detail to the embodiments of the present invention, examples of which are illustrated in the accompanying drawings.

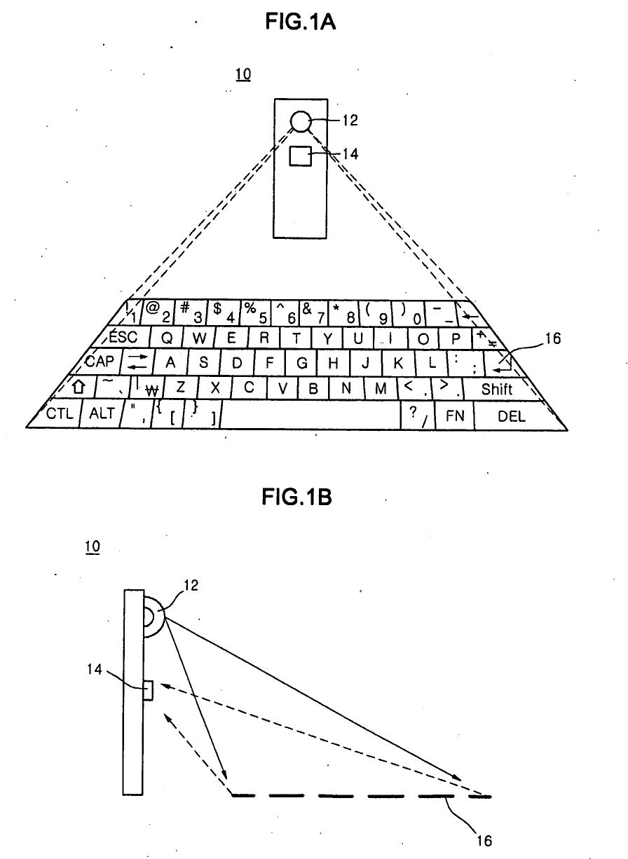

FIGS. 1A and 1B are a front view and a side view of an input unit, respectively, according to an embodiment of the invention.

Referring to FIGS. 1A and 1B, the input unit according to an embodiment includes an input pattern generator 12 for generating an input pattern, and an image receiver 14 for capturing an image. The input unit can be provided in a mobile terminal such as a PDA, a smart phone, a handset, etc., and all the components of the input unit are operatively coupled and configured.

When a light formed in the shape of a predetermined pattern is emitted from the input pattern generator 12, an input pattern 16 is generated on a lower surface. Though FIG. 1 exemplarily illustrates that a keyboard-shaped optical input pattern is formed, the present invention is not limited thereto and includes various types of input patterns that can replace a mouse, a touchpad, and other conventional input units. For example, an image of the input pattern projected by the input pattern generator 12 may be an image of a keyboard, a keypad, a mouse, a touchpad, a menu, buttons, or any combination thereof, where such image can be an image of any input device in any type or shape or form.

Also, an ‘input member’ in the present disclosure includes all devices used for performing a predetermined input operation using the input unit. Preferably, the input member includes a human finger, but can include other objects such as a stylus pen depending on embodiments.

Further, the image receiver 14 is separated by a predetermined distance from the input pattern generator 12, and is disposed below the input pattern generator 12. The image receiver 14 captures the projected input pattern, the input member (e.g., a user's finger over the projected input pattern), and a shadow image of the input member.

The image receiver 14 may be disposed below the input pattern generator 12 so that an image corresponding to a noise is not captured.

The image receiver 14 preferably has an appropriate frame rate in order to capture the movement of the input member and determine whether the input member has made an input (e.g., whether or not the input member contacts the displayed input pattern). For example, the image receiver 14 can have a rate of about 60 frames/sec.

If a user makes an input to the input unit, an image captured by the image receiver 14 is processed and identified by an image processor of the input unit to include the displayed input pattern (e.g., projected keyboard image), the input member (e.g., user's finger over the keyboard image), and the shadow image of the input member. The image processor detects the positions of the input member and the shadow and executes a command corresponding to a contact point of the input member. For instance, the image processor analyzes the positions of the input member and shadow in the captured image, determines which part of the displayed input pattern the input member has contacted, and executes a command corresponding to the selection of that part of the displayed input pattern.

A method of identifying, in the image processor of the input unit, each object from the received image, and a method of judging, by the image processor, whether the input member has made a contact will be described later according to an embodiment of the invention.

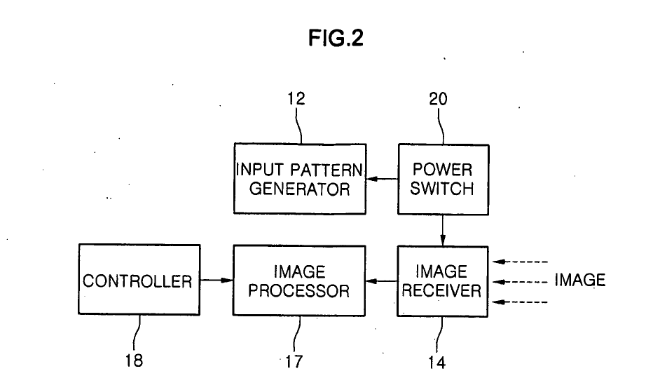

FIG. 2 is a block diagram of an input unit according to an embodiment. The input unit in FIGS. 1A and 1B and in any other figures of the present disclosure can have the components of the input unit of FIG. 2.

Referring to FIG. 2, the input unit includes an input pattern generator 12, an image receiver 14, an image processor 17, and a controller 18. All components of the input unit of FIG. 2 are operatively coupled and configured.

The elements 12 and 14 of FIG. 2 can be the same as the elements 12 and 14 of FIGS. 1A and 1B. For instance, the input pattern generator 12 generates an input pattern (e.g., an image of a keyboard, keypad, etc.) as discussed above. The image receiver 14 (e.g., a camera) captures the input pattern projected by the input pattern generator 12, a portion of an input member, and a shadow image corresponding to the portion of the input member. For instance, the image receiver 14 may have a preset range of an area that the image receiver 14 is responsible for, and any image that falls within the preset range can be captured by the receiver 14.

The image processor 17 then receives the captured image from the receiver 14 and processes it. For example, the image processor 17 detects a position related with the portion of the input member and the portion of the shadow image, from the captured image received by the image receiver 14. The image processor 17 determines a contact point of the input member (e.g. a point on the input pattern that the input member contacted) based on the detected position information, and generates and/or executes a command corresponding to the contact point of the input member. The controller 18 controls the image processor 17 to execute the command corresponding to the contact point when the portion (e.g., a tip of the finger or stylus) of the input member contacts a part of the input pattern. The controller 18 can control other components and operations of the input unit.

The input unit of the present invention can further include a power switch 20 for turning on and off the input unit. In such a case, the input pattern generator 12 and the image receiver 14 may be selectively turned on and off under control of the power switch 20. As a variation, the input unit may be turned on and off in response to a control signal from a controller included in the mobile terminal or other device having the input unit therein.

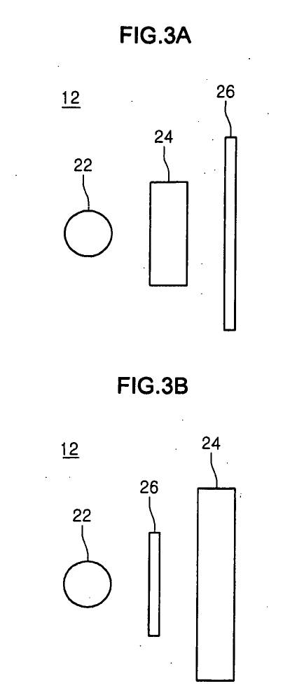

Referring to FIG. 3A illustrating one example of the input pattern generator 12, the input pattern generator 12 can include a light source 22 for emitting a light, a lens 24 for condensing the light emitted from the light source 22, and a filter 26 for passing the light emitted from the lens 24. The filter 26 includes a filter member or a pattern for forming the input pattern.

As a variation to FIG. 3B, the filter 26 can be located between the light source 22 and the lens 24 to generate an input pattern.

Examples of the light source 22 include various kinds of light sources such as a laser diode (LD), a light emitting diode (LED), etc. Light emitted from the light source 22 passes through the lens 24 and the filter 26 (in any order) to generate an image of a specific pattern, e.g., in a character input space. The light source 22 is configured to emit a light having intensity that can be visually perceived by a user.

Depending on an embodiment, the light source 22 can be divided into a generation light source for generating a visible light pattern that can be perceived by a user (e.g., for projecting an input pattern), and a detection light source for generating an invisible light for detecting whether or not the input member contacts the input pattern. For example, one light source 22 may be provided for generating an image pattern and/or generating a detection beam. In the alternative, two separate light sources 22, 22 can be provided to respectively generate an image pattern and a detection beam.

The lens 24 can be a collimate lens and allows a light incident thereto to be visually perceived by a user and magnifies, corrects, and reproduces in a size that can be sufficiently used by the input member.

The filter 26 is, e.g., a thin film type filter and includes a pattern corresponding to an input pattern to be formed. For example, a SLM (spatial light modulator) filer may be used as the filter 26 for projecting different types of images including different types of input patterns.

The image receiver 14 captures and receives the input pattern generated by the input pattern generator 12, a portion of the input member, and a shadow corresponding to the portion of the input member as discussed above.

The image receiver 14 can be implemented using a camera module and can further include a lens at the front end of the image receiver 14 in order to allow an image to be formed on a photosensitive sensor inside the camera module. A complementary metal oxide semiconductor (CMOS) type photosensitive sensor can control a shooting speed depending on a shooting size. When the CMOS type photosensitive sensor is driven in a low resolution mode at a level that allows shooting of a human finger operation or speed, information required for implementing the present disclosure can be obtained.

The image processor 17 identifies the input pattern, a portion of the input member, and a corresponding shadow image from the image received by the image receiver 14, and detects the positions of the portions of the input member and the shadow thereof or positions related thereto to execute a command corresponding to the contact point of the portion of the input member.

If the image processor 17 judges that the portion of the input member contacts the input pattern projected on a surface, the controller 18 controls the image processor 17 to execute the command corresponding to the contact point of the input member.

Therefore, since the input unit according to the present invention is composed of a small number of parts, the size and costs of the input unit can reduced.

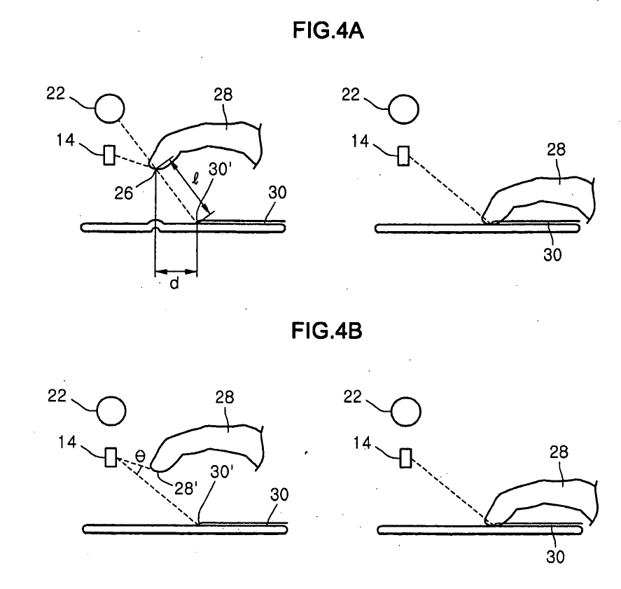

FIGS. 4A and 4B are views illustrating different methods of judging whether or not an input is made by an input member according to an embodiment of the present invention. These methods of the present invention are preferably implemented using the various examples of the input unit of the present invention, but may be implemented by other suitable input units.

Particularly, FIGS. 4A and 4B are views illustrating different methods of judging when an input member 28 (e.g., finger, stylus, pen, etc.) falls within a contact range of the input pattern to determine if an input is made. The contact range of the input pattern can be set to cover only a direct contact of the input member 28 on the input pattern, or to cover both the direct contact of the input member 28 and positioning of the input member 28 over the input pattern within a preset distance therebetween. For example, the input unit can be set such that it decides that an input is made if the input member 28 contacts the input pattern, or as a variation if the input member 28 is positioned closely (within a preset distance) over the input pattern.

As shown in FIG. 4A, a determination of whether the input member 28 falls within a contact range of the input pattern (i.e., whether an input is made by the input member) can be made using a distance difference (d or l) between a portion of the input member 28 and a shadow 30 of the portion of the input member 28 calculated from the captured image. In another example as shown in FIG. 4B, the same determination can be made using an angle difference θ between the portion of the input member 28 and the shadow 30 generated by the portion of the input member 28 from the captured image.

The light source 22 is part of the input pattern generator 12 of FIGS. 2, 3A and/or 3B. The lens 24 or the filter 26 of the input pattern generator 12 (shown in FIGS. 3A and 3B) is provided, but not shown, in FIGS. 4A and 4B for the sake of brevity. The image receiver 14 separated by a predetermined distance below the input pattern generator 12 (i.e., the light source 22) captures an image of an input pattern, an image of the input member 28, and corresponding shadow image 30 (e.g., shadow of the input member 28). Next, the image processor (e.g., image processor 17 in FIG. 2) of the input unit identifies the input pattern, the image of the input member 28, and the corresponding shadow image 30 from the image captured by the image receiver 14, and determines the positions (e.g., distance, angle, etc.) of these respective objects.

According to an embodiment, the image processor can judge whether the input member 28 contacts the input pattern projected on some surface by detecting the portion of the input member 28 and the portion of the corresponding shadow 30, or the positions related thereto.

For example, the image processor can continuously detect the position of the end 28′ of the input member 28 and the position of the end 30′ of the shadow 30 from the image received from the image receiver 14.

If the input member is a finer for example, the image processor can detect the position(s) of a finger tip of the input member 28 and/or the shadow 30 in order to judge whether or not the input member 28 contacts the input pattern (i.e., whether an input has been made by the input member).

Also, depending on an embodiment, positions offset by a predetermined distance from the ends 28′ and 30′ of the input member 28 and the shadow 30 can be detected and used for judging whether the input is made by the input member (e.g., whether or not the input member 28 contacts the input pattern, or whether or not the input member 28 comes close to the input pattern).

Also, according to the present disclosure, whether the input member 28 contacts or sufficiently comes close to the project input pattern can be judged on the basis of variables changing as the input member 28 comes close to the input pattern surface such as angle relation, a relative velocity, and/or a relative acceleration besides the distance relation between the positions related with the portion of the input member 28 and the shadow 30 thereof.

Although a case of using position information of the end 28′ of the input member 28 and the end 30′ of the shadow 30 is discussed in FIGS. 4A and 4B, the above-described various reference values (e.g., relative velocity, relative acceleration, etc.) can be used in order to judge whether the input member contacts or sufficiently comes close to the projected input pattern.

Since the technologies for identifying an object from a captured image are well known to those of ordinary skill in the art, the detailed description thereof is omitted for the sake of brevity

Also, since the technologies for identifying an object from an image captured through image processing and finding out a boundary line using, e.g., a brightness difference between adjacent pixels are also well known to and widely used by those of ordinary skill in the art, some descriptions of image processing methods used for calculating the positions of a portion of the input member 28 and the portion of the shadow image 30, or positions related thereto are omitted. All these known technologies can be used in the present invention.

In the example of FIG. 4A, a distance difference between the end 28′ of the input member 28 and the end 30′ of the shadow 30, or a distance difference between positions related with the input member 28 and the shadow 30 is continuously calculated by the image processor of the input unit. When the calculated distance difference is 0 (which indicates a direct contact of the input member on the input pattern) or some value that falls within a preset range (which indicates that the input member is positioned close enough to the input pattern), it can be judged that the input member 28 falls within a contact range of the input pattern and that an input is made by the input member 28. Depending on an embodiment, when the calculated distance difference becomes a predetermined threshold value or less, it can be judged that the input member 28 contacts the input pattern.

At this point, even in a case of detecting another portion related with the input member 28 or the shadow 30 instead of the ends 28′ and 30′ of the input member 28 and the shadow 30, a point when a distance between other portions related with the input member 28 and the shadow 30 is 0 or a predetermined threshold value or less can be detected. For example, instead of using the ends 28′ and 30′ to determine the positional relationship between the input member 28 and the shadow 30, other parts of the input member 28 and the shadow 30 may be used to make this determination.

Also, depending on an embodiment, even in the case where the input member 28 does not actually contact the surface (input pattern), when the input member 28 comes close within a predetermined distance from the input pattern, the image processor of the input unit can judge that the input member contacts the input pattern (an input is made).

The distance between the input member and its shadow can be judged using a straight line distance R between the end 28′ of the input member 28 and the end 30′ of the shadow, or using a horizontal distance d between a corresponding position of the input member end 28′ downwardly projected on the surface and the shadow end 30′.

According to another example, an angle θ between the input member end 28′ and the shadow end 30′ is calculated to determine whether the input member end 28′ falls within the contact range of the input pattern (i.e., whether an input is made) as illustrated in FIG. 4B. Depending on an embodiment, whether the input member falls within the contact range can be judged on the basis of an angle between portions related with the input member 28 and the shadow 30.

Referring to the left drawings of FIGS. 4A and 4B, when the input member 28 does not contact the input pattern, the distance l or d between the input member end 28′ and the shadow end 30′ has a non-zero value, or the angle θ between the input member end 28, and the shadow end 30′ has a non-zero value. However, when the input member 28 contacts the input pattern, the above values l, d, and θ become zero, and thus using these values, it can be judged that the input member 28 has contacted the input pattern.

As described above, depending on an embodiment, when each of the above values l, d, and θ becomes a predetermined threshold value or less, it can be judged that the input member 28 contacts the input pattern.

As described above, when the input member 28 comes close within a predetermined distance to the input pattern even though a contact of the input pattern does not actually occur, the input member can be judged to be in contact with the input pattern and a subsequent process can be performed.

When the input member 28 contacts the input pattern such as the virtual keyboard image (16), plane coordinates corresponding to the contact point can be calculated through the image processing by analyzing the image captured by the image receiver. That is, by determining the exact contact location on the input pattern, a user's specific input (e.g., selecting a letter “K” on the keyboard image 16) can be recognized. When the controller of the input unit orders a command corresponding to the coordinates of the contact point to be executed, the image processor (or other applicable components in the input unit or the mobile device) executes the command.

According to an embodiment, as a reference for judging whether the input member 28 contacts the input pattern, the relative velocities and/or accelerations of the input member end 28′ and the shadow end 30′ can also be used.

For example, when the relative velocities of the input member end 28′ and/or the shadow end 30′ are zero, the image processor can judge that the positions of the two objects are fixed. Assuming that a direction in which the input member end 28′ and the shadow end 30′ come close is a (+) direction, and a direction in which the input member end 28′ and the shadow end 30′ move away is a (−) direction, when the relative velocity has a (+) value, the image processor can judge that the input member 28 comes close to the input pattern. On the other hand, when the relative velocity has a (−) value, the image processor can judge that the input member 28 moves away from the input pattern.

That is, a relative velocity is preferably calculated from continuously-shotimages over continuous time information. When the relative velocity changes from a (+) value to a (−) value in an instant, it is judged that a contact occurs. Also, when the relative velocity has a constant value, it is judged that a contact occurs.

Also, acceleration information is continuously calculated, and when an (−) acceleration occurs in an instant, it is judged that a contact occurs. At the point of contact, the acceleration will change instantly, which can be detected as a contact occurrence.

As a variation, instead of using the input member end and the shadow end, the relative velocity information or acceleration information of other portions of the input member 28 and the shadow 30 or other positions related thereto can be calculated and used to determine if an input is made by the input member 28.

To realize a computer algorithm on the basis of the above-described technology, continuous time information (that is, continuous shot images) is used. For this purpose, a construction that can constantly store and perform an operation on extracted information may be provided.

Therefore, for this purpose, image processing of an image received by the image receiver 14 is used. For example, images can be extracted over three continuous times t₀, t₁, and t₂, and a velocity and/or an acceleration can be calculated on the basis of the extracted images. Also, the continuous times to, t₁, and t₂ may be constant intervals.

Judging whether the input member 28 contacts or not using the velocity information and/or the acceleration information can be used as a method of complementing a case where the calculation and use of the distance information or the angle information may not be easy or appropriate.

Accordingly, a determination of whether or not an input is made (i.e., whether or not a portion of the input member falls within a contact range of the input pattern) can be made by determining relationship information between an image of the portion of the input member and an image of the corresponding shadow. The relationship information can include at least one of the following: a distance between the portion of the input member and the portion of the shadow of the input member; a distance between a point on the input pattern that corresponds to the portion of the input member, and the portion of the shadow of the input member; an angle between the portion of the input member and the portion of the shadow of the input member; a velocity or acceleration of the input member; and a velocity or acceleration of the shadow of the input member.

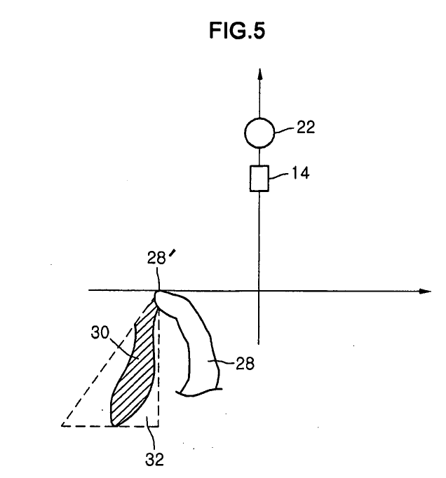

According to an embodiment, the entire image of the input pattern having the input member 28 and the shadow 30 over it is captured by the image receiver 14. The input member 28 and the shadow 30 are identified from the entire captured image, so that positions thereof can be calculated. However, to identify each object from the entire captured image, a large number of operations may be needed and so the time to identify the images and to determine if an input is made may take longer than desirable. To address this concern, a method according to an embodiment of FIG. 5 may be used.

FIG. 5 is a diagram for explaining a method of measuring a position according to an embodiment of the invention, which can be used in a method of determining the positions of the input member end 28′ and the shadow end.

As shown in FIG. 5, in this embodiment, instead of analyzing all the images captured by the image receiver, only a particular or preset region (e.g., a shadow searching region 32) of the images may be analyzed. For example, since the light source 22 and the image receiver 14 are stationary, a candidate region, i.e., the shadow searching region 32 can be set or defined on the basis of the position information of the light source 22 and the image receiver 14, e.g., based on the boundary of the input pattern, etc. The controller 18 or the image processor 17 may set the shadow searching region 32. Then the position of the shadow end can be detected and measured by examining only the set shadow searching region 32. For instance, once a possible location of an input member over the input pattern can be ascertained, then based on the location of the light impinging from the light source 22 and the location of the image receiver 14, a possible location for a shadow corresponding to the input member over the input pattern may be determined. Then the range of such possible locations may be used to define the shadow searching region 32. Then an end of a shadow of the input member may be located by analyzing only the shadow searching region 32.

As the shadow searching region 32, which can be a region estimated using the position information of the light source 22 and the image receiver 14, and the measured position of the input member 28, for example, an isosceles triangle-shaped region can be set.

Therefore, a position at which the shadow 30 is to be formed is modeled using the detected input member end 28′ as a reference point on the basis of the already known position of the light source 22. Since only the shadow searching region 32 is searched and analyzed to locate the end 30′ of the shadow 30 of the input member 28, the image processing operation may not be performed on the other regions. Therefore, the number of operations for identifying an object as well as the time taken to complete these operations can be reduced considerably.

Also, the shadow searching region 32 is set on the basis of the position of the light source 22 to measure the position of the shadow end, so that an external effect generated by outside light interference can be removed.

As a variation, although the shadow searching region 32 may be preset, the shadow searching region 32 may be dynamically changed. For example, as the input pattern varies, the size and/or shape of the shadow searching region may change.

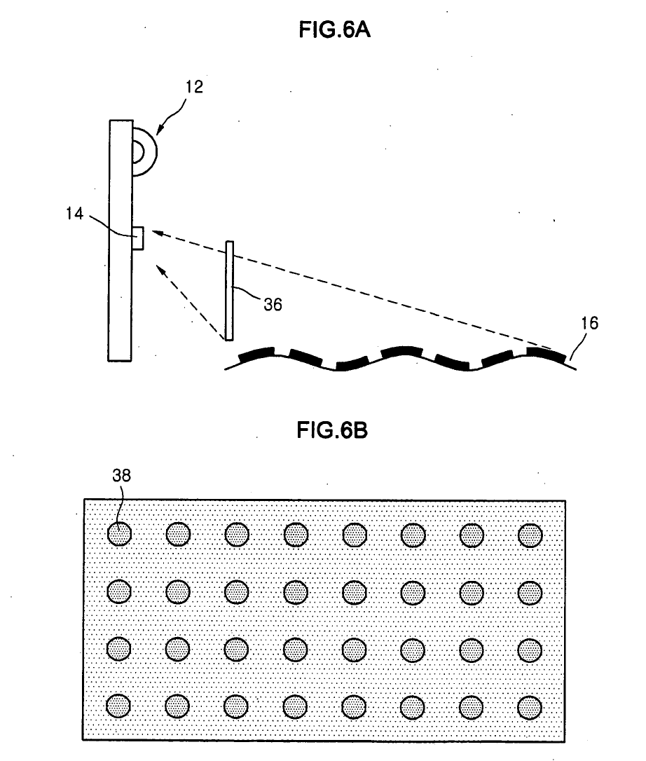

FIGS. 6A and 6B are views illustrating a process of correcting a captured image to convert the image into an inversely operated and normalized image, in order to more accurately calculate which input has been made on the input pattern. For example, if the input pattern is a virtual keyboard (keyboard 16 as shown in FIG. 1) and the surface onto which the input pattern is projected is uneven, the virtual keyboard as displayed may be skewed or distorted. According this embodiment, markers are used to detect such distortion so that the distorted virtual keyboard image can be corrected or compensated. The markers can be some indications made by a visible light or an invisible light. For example, the light source 22 can generate both the input pattern and the markers, using one light source or multiple light sources. The input unit can include two separate light sources 22, 22 for respectively generating the input pattern and the markers, or can include a single light source 22 for generating both the input pattern and the markers.

Since the image receiver 14 for capturing and receiving an image according to an embodiment is located on the lateral side of the input unit, distortions may be generated at up and down, and left and right of the image. Therefore, when an image captured by the image receiver is corrected and converted into an inversely operated and normalized image, and projected onto a transparent plane 36, the image can be corrected so that the distortions are not generated at up and down, and left and right of the image, as illustrated in FIG. 6A.

Also, when the input unit of the present disclosure is used to project an input pattern on a surface that is uneven or irregular, image processing of the captured image may be performed after the image is inversely operated and normalized through the correcting process.

Such a process is referred to as camera calibration, which is well known in the art. Accordingly, a detailed description thereof is omitted.

According to an embodiment, for example, in the case where an input pattern is a keyboard, markers 38 can be arranged at constant intervals in a pattern region as illustrated in FIG. 6B. The proper intervals and positions of the markers 38 are stored in advance. Each of the markers 38 can be matched with each pattern/key/portion of the keyboard to be formed. After that, images received by the image receiver 14 are image-processed, and the interval and position of each marker 38 as captured by the image receiver 14 are compared with the proper interval and position of the markers 38 that are prestored in advance. Based on this comparison result, the degree of distortion or irregularity in the image is judged. And based on this judgment result, an appropriate correction to compensate for the distortion can be performed. Here, the arrangement shape, interval, and size of the marker can be changed depending on an embodiment.

For detecting if an input is made by the input member, there may be two types of input detection: a case where the calculation of the absolute coordinates of the input member is needed (for example, a keyboard), and a case where the calculation of the relative coordinates of the input member is sufficient (for example, a mouse). In the case where the calculation of the absolute/exact coordinates of the input member is needed, the calibration process may be performed. For example, depending on which input pattern is currently projected, the input unit can be set up to variably change its settings so that a proper position calculation may be adaptively performed according to the currently displayed input pattern.

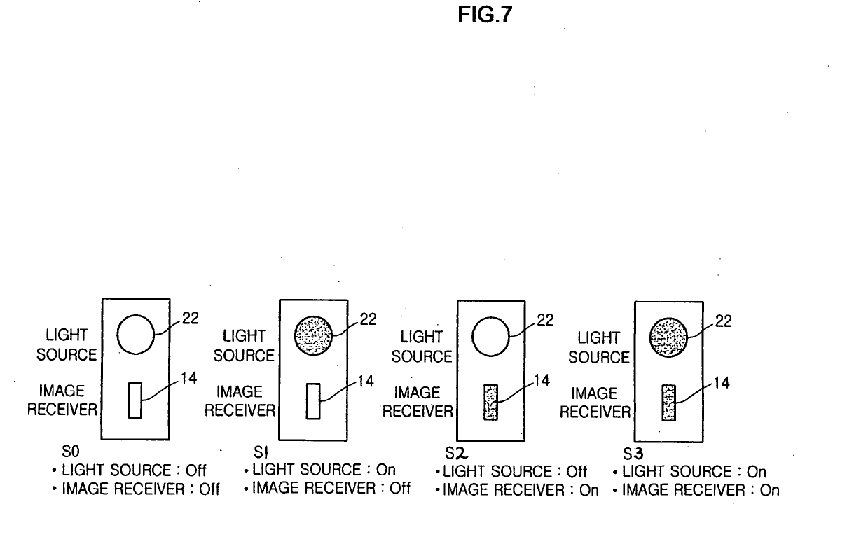

FIG. 7 is a view illustrating a method of controlling the power of an input unit according to an embodiment. Power applied to the input unit can be flexibly and selectively controlled according to a utilization method of a user or a use pattern of a user. Generally, since the power consumption of the light source 22 for illuminating the light and the image receiver 14 for capturing and receiving an image is high, this embodiment reduces power consumption by the input unit by selectively turning on/off the light source and the image receiver of the input unit.

To control the power, the input unit according to an embodiment may further include a power switch for controlling the power supplied to the light source 22 and the image receiver 14.

According to this embodiment, four modes in total can be set depending on the methods of controlling the powers of the light source 22 and the image receiver 14. The four modes include a mode S0 where both the light source 22 and the image receiver 14 are turned off, a mode S1 where only the light source 22 is turned on (while the image receiver 14 is turned off), a mode S2 where only the image receiver 14 is turned on (while the light source 22 is turned off), and a mode S3 where both the light source 22 and the image receiver 14 are turned on.

In an embodiment, the input unit is generally driven in the mode S3. Whether there exists a user's input can be judged using the mode S2. Also, the mode S1 may be suitable for an embodiment using only the light source in the case where the image processing is not needed, and the mode S0 is prepared for the case where a user does not use the input unit.

Controlling these modes can be performed, by a user's manual manipulation, or automatically depending on an embodiment. For example, when the input member is not captured for a predetermined time by the image receiver 14, the mode S3 can be automatically changed to another mode, e.g., S0. When the input member is captured again, the current mode can be switched to the mode S3.

As described above, the light source 22 and the image receiver 14 are selectively turned on/off depending on an embodiment of the user, so that the powers applied to these components may be flexibly controlled and the power consumption by these components can be reduced.

The input unit according to an embodiment can be mounted or disposed in a mobile device such as a cellular phone, an MP3 player, a computer notebook, a personal digital assistant (PDA), etc.

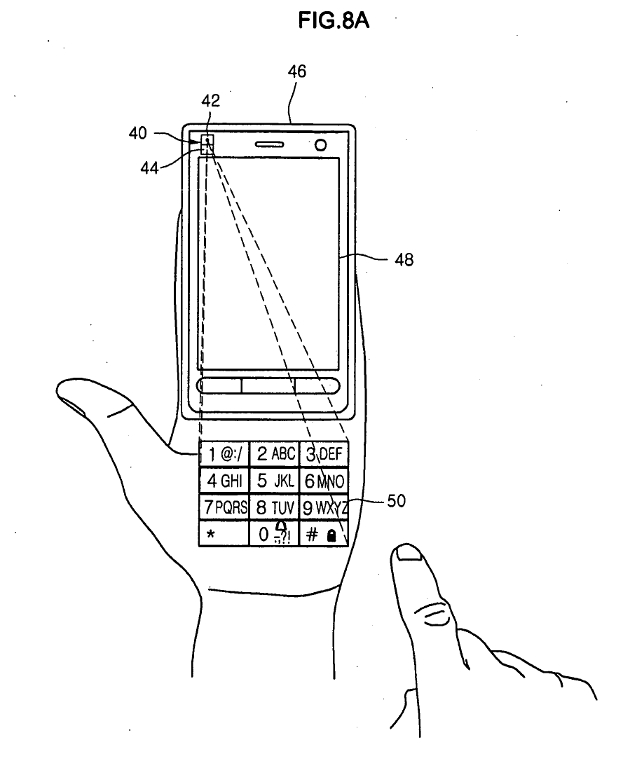

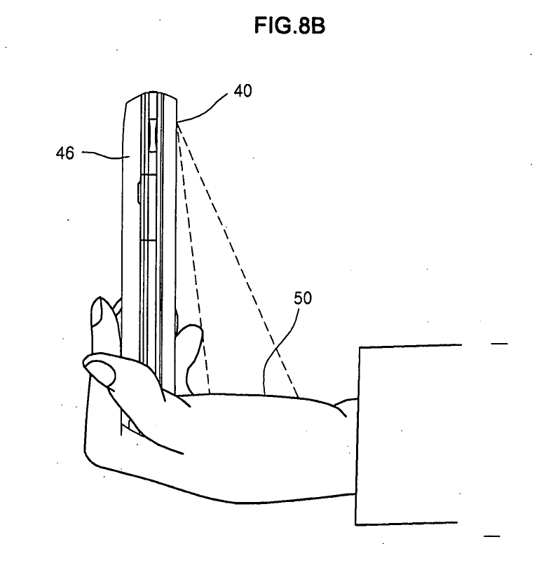

FIGS. 8A and 8B are views illustrating a portable terminal having an input unit according to an embodiment.

Referring to FIGS. 8A and 8B, the present invention provides a portable terminal 46 (or mobile device) having an input unit 40, and an input interface (e.g., a virtual keypad 50) output by the input unit 40. The input unit 40 can be any input unit discussed above according to various embodiments.

For example, when a user places the portable terminal on the palm of his hand, a virtual keypad (input pattern) is output from the portable terminal and displayed on the palm surface of the hand. The user can touch the virtual keypad with the other hand to input desired numbers and characters. For instance, the user can use his finger tip to make an input selection on the virtual keypad (e.g., by contacting a key displayed on the palm surface or coming close to the palm surface where the key is displayed).

The input unit 40 allows the virtual keypad 50 and a detection region to be output from a light source 42 divided into a generation light source and a detection light source such that the virtual keypad and the detection region overlap each other and are displayed on the palm.

At this point, a camera 44 captures a finger and a shadow thereof contacting the virtual keypad 50 to judge whether the finger contacts the keypad or not, and to calculate the coordinates of the contact point. Also, a number and/or a character on the virtual keypad, corresponding to the calculated coordinates can be input to the portable terminal. Here, the input number and character can be displayed on a display screen 48 of the portable terminal 46. For example, if the user selects a number “2” on the displayed keypad 50 by contacting that key using the finger tip, then the selected number “2” is displayed on the display screen 48 of the portable terminal 46. In this way, the effect of making an input using the virtual keypad or any other input pattern is preferably the same as making an input using a conventional keypad (hardware) or the like.

The input unit according to an embodiment can be applied to various types of mobile devices and non-mobile devices. Examples of the mobile devices include, but are not limited to, a cellular phone, a smart phone, a notebook computer, a digital broadcasting terminal, a personal digital assistant (PDA), a portable multimedia player (PMP), and a navigator.

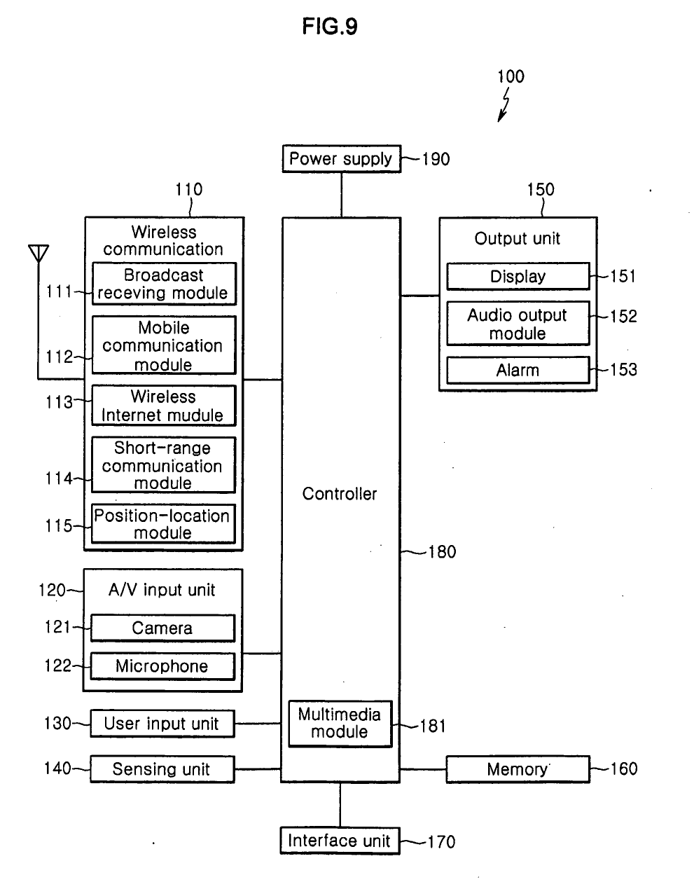

FIG. 9 is a block diagram of a mobile device 100 in accordance with an embodiment of the present invention. The mobile device 100 includes the input unit discussed above according to the embodiments of the invention. All components of the mobile device are operatively coupled and configured.

The mobile device may be implemented using a variety of different types of devices. Examples of such devices include mobile phones, user equipment, smart phones, computers, digital broadcast devices, personal digital assistants, portable multimedia players (PMP) and navigators. By way of non-limiting example only, further description will be with regard to a mobile device. However, such teachings apply equally to other types of devices. FIG. 9 shows the mobile device 100 having various components, but it is understood that implementing all of the illustrated components is not a requirement. Greater or fewer components may alternatively be implemented.

FIG. 9 shows a wireless communication unit 110 configured with several commonly implemented components. For instance, the wireless communication unit 110 typically includes one or more components which permits wireless communication between the mobile device 100 and a wireless communication system or network within which the mobile device is located.

The broadcast receiving module 111 receives a broadcast signal and/or broadcast associated information from an external broadcast managing entity via a broadcast channel. The broadcast channel may include a satellite channel and a terrestrial channel. The broadcast managing entity refers generally to a system which transmits a broadcast signal and/or broadcast associated information. Examples of broadcast associated information include information associated with a broadcast channel, a broadcast program, a broadcast service provider, etc. For instance, broadcast associated information may include an electronic program guide (EPG) of digital multimedia broadcasting (DMB) and electronic service guide (ESG) of digital video broadcast-handheld (DVB-H).

The broadcast signal may be implemented as a TV broadcast signal, a radio broadcast signal, and a data broadcast signal, among others. If desired, the broadcast signal may further include a broadcast signal combined with a TV or radio broadcast signal.

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), the data broadcasting system known as media forward link only (MediaFLO®) and integrated services digital broadcast-terrestrial (ISDB-T). Receiving of multicast signals is also possible. If desired, data received by the broadcast receiving module 111 may be stored in a suitable device, such as memory 160.

The mobile communication module 112 transmits/receives wireless signals to/from one or more network entities (e.g., base station, Node-B). Such signals may represent audio, video, multimedia, control signaling, and data, among others.

The wireless internet module 113 supports Internet access for the mobile device. This module may be internally or externally coupled to the device.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

Position-location module 115 identifies or otherwise obtains the location of the mobile device. If desired, this module may be implemented using global positioning system (GPS) components which cooperate with associated satellites, network components, and combinations thereof.

Audio/video (A/V) input unit 120 is configured to provide audio or video signal input to the mobile device. As shown, the A/V input unit 120 includes a camera 121 and a microphone 122. The camera receives and processes image frames of still pictures or video.

The microphone 122 receives an external audio signal while the portable device is in a particular mode, such as phone call mode, recording mode and voice recognition. This audio signal is processed and converted into digital data. The portable device, and in particular, A/V input unit 120, typically includes assorted noise removing algorithms to remove noise generated in the course of receiving the external audio signal. Data generated by the A/V input unit 120 may be stored in memory 160, utilized by output unit 150, or transmitted via one or more modules of communication unit 110. If desired, two or more microphones and/or cameras may be used.

The user input unit 130 generates input data responsive to user manipulation of an associated input device or devices. Examples of such devices include a keypad, a dome switch, a touchpad (e.g., static pressure/capacitance), a touch screen panel, a jog wheel and a jog switch.

The input units according to the embodiments of the present invention can be used as or as part of the user input unit 130.

The sensing unit 140 provides status measurements of various aspects of the mobile device. For instance, the sensing unit may detect an open/close status of the mobile device, relative positioning of components (e.g., a display and keypad) of the mobile device, a change of position of the mobile device or a component of the mobile device, a presence or absence of user contact with the mobile device, orientation or acceleration/deceleration of the mobile device.

The sensing unit 140 may comprise an inertia sensor for detecting movement or position of the mobile device such as a gyro sensor, an acceleration sensor etc. or a distance sensor for detecting or measuring the distance relationship between the user's body and the mobile device.

The interface unit 170 is often implemented to couple the mobile device with external devices. Typical external devices include wired/wireless headphones, external chargers, power supplies, storage devices configured to store data (e.g., audio, video, pictures, etc.), earphones, and microphones, among others. The interface unit 170 may be configured using a wired/wireless data port, a card socket (e.g., for coupling to a memory card, subscriber identity module (SIM) card, user identity module (UIM) card, removable user identity module (RUIM) card), audio input/output ports and video input/output ports.

The output unit 150 generally includes various components which support the output requirements of the mobile device. Display 151 is typically implemented to visually display information associated with the mobile device 100. For instance, if the mobile device is operating in a phone call mode, the display will generally provide a user interface or graphical user interface which includes information associated with placing, conducting, and terminating a phone call. As another example, if the mobile device 100 is in a video call mode or a photographing mode, the display 151 may additionally or alternatively display images which are associated with these modes.

A touch screen panel may be mounted upon the display 151. This configuration permits the display to function both as an output device and an input device.

The display 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile device may include one or more of such displays.

FIG. 9 further shows an output unit 150 having an audio output module 152 which supports the audio output requirements of the mobile device 100. The audio output module is often implemented using one or more speakers, buzzers, other audio producing devices, and combinations thereof. The audio output module functions in various modes including call-receiving mode, call-placing mode, recording mode, voice recognition mode and broadcast reception mode. During operation, the audio output module 152 outputs audio relating to a particular function (e.g., call received, message received, and errors).

The output unit 150 is further shown having an alarm 153, which is commonly used to signal or otherwise identify the occurrence of a particular event associated with the mobile device. Typical events include call received, message received and user input received. An example of such output includes the providing of tactile sensations (e.g., vibration) to a user. For instance, the alarm 153 may be configured to vibrate responsive to the mobile device receiving a call or message. As another example, vibration is provided by alarm 153 as a feedback responsive to receiving user input at the mobile device, thus providing a tactile feedback mechanism. It is understood that the various output provided by the components of output unit 150 may be separately performed, or such output may be performed using any combination of such components.

The memory 160 is generally used to store various types of data to support the processing, control, and storage requirements of the mobile device. Examples of such data include program instructions for applications operating on the mobile device, contact data, phonebook data, messages, pictures, video, etc. The memory 160 may be implemented using any type (or combination) of suitable volatile and non-volatile memory or storage devices including random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or disk, card-type memory, or other similar memory or data storage device.

The controller 180 typically controls the overall operations of the mobile device. For instance, the controller performs the control and processing associated with voice calls, data communications, video calls, camera operations and recording operations. If desired, the controller may include a multimedia module 181 which provides multimedia playback. The multimedia module may be configured as part of the controller 180, or this module may be implemented as a separate component.

The power supply 190 provides power required by the various components for the portable device. The provided power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, such embodiments are implemented by controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory (for example, memory 160), and executed by a controller or processor (for example, controller 180).

The mobile device 100 of FIG. 9 may be configured to operate within a communication system which transmits data via frames or packets, including both wireless and wireline communication systems, and satellite-based communication systems. Such communication systems utilize different air interfaces and/or physical layers.

Examples of such air interfaces utilized by the communication systems include example, frequency division multiple access (FDMA), time division multiple access (TDMA), code division multiple access (CDMA), and universal mobile telecommunications system (UMTS), the long term evolution (LTE) of the UMTS, and the global system for mobile communications (GSM). By way of non-limiting example only, further description will relate to a CDMA communication system, but such teachings apply equally to other system types.

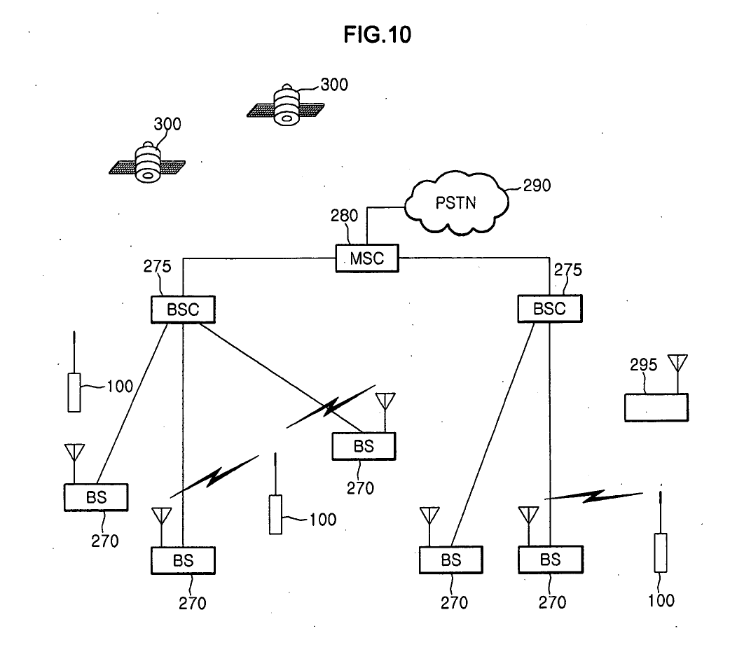

Referring now to FIG. 10, a CDMA wireless communication system is shown having a plurality of mobile devices 100, a plurality of base stations 270, base station controllers (BSCs) 275, and a mobile switching center (MSC) 280. The MSC 280 is configured to interface with a conventional public switch telephone network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. It is to be understood that the system may include more than two BSCs 275.

Each base station 270 may include one or more sectors, each sector having an omnidirectional antenna or an antenna pointed in a particular direction radially away from the base station 270. Alternatively, each sector may include two antennas for diversity reception. Each base station 270 may be configured to support a plurality of frequency assignments, with each frequency assignment having a particular spectrum (e.g., 1.25 MHz, 5 MHz).

The intersection of a sector and frequency assignment may be referred to as a CDMA channel. The base stations 270 may also be referred to as base station transceiver subsystems (BTSs). In some cases, the term “ebase station” may be used to refer collectively to a BSC 275, and one or more base stations 270. The base stations may also be denoted “cell sites.” Alternatively, individual sectors of a given base station 270 may be referred to as cell sites.

A terrestrial digital multimedia broadcasting (DMB) transmitter 295 (FIG. 10) is shown broadcasting to portable/mobile devices 100 operating within the system. The broadcast receiving module 111 (FIG. 9) of the portable device is typically configured to receive broadcast signals transmitted by the DMB transmitter 295. Similar arrangements may be implemented for other types of broadcast and multicast signaling (as discussed above).

FIG. 10 further depicts several global positioning system (GPS) satellites 300. Such satellites facilitate locating the position of some or all of the portable devices 100. Two satellites are depicted, but it is understood that useful positioning information may be obtained with greater or fewer satellites. The position-location module 115 (FIG. 9) of the portable device 100 is typically configured to cooperate with the satellites 300 to obtain desired position information. It is to be appreciated that other types of position detection technology, (i.e., location technology that may be used in addition to or instead of GPS location technology) may alternatively be implemented. If desired, some or all of the GPS satellites 300 may alternatively or additionally be configured to provide satellite DMB transmissions.

During typical operation of the wireless communication system, the base stations 270 receive sets of reverse-link signals from various mobile devices 100. The mobile devices 100 are engaging in calls, messaging, and other communications. Each reverse-link signal received by a given base station 270 is processed within that base station. The resulting data is forwarded to an associated BSC 275. The BSC provides call resource allocation and mobility management functionality including the orchestration of soft handoffs between base stations 270. The BSCs 275 also route the received data to the MSC 280, which provides additional routing services for interfacing with the PSTN 290. Similarly, the PSTN interfaces with the MSC 280, and the MSC interfaces with the BSCs 275, which in turn control the base stations 270 to transmit sets of forward-link signals to the mobile devices 100.

Any reference in this specification to “one embodiment,” “an embodiment,” “example embodiment,” etc., means that a particular feature, structure, or characteristic described in connection with the embodiment is included in at least one embodiment (one or more embodiments) of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for controlling an input unit, the method comprising:
forming an input pattern;
capturing an image of an input member over the input pattern;
first determining relationship information between a portion of the input member and a portion of a shadow of the input member using the captured image;
second determining whether the input member falls in a contact range of the input pattern based on the relationship information; and
executing a command based on the second determination result.

2. The method according to claim 1, wherein the relationship information includes at least one of the following:
a distance between the portion of the input member and the portion of the shadow of the input member;
a distance between a point on the input pattern that corresponds to the portion of the input member, and the portion of the shadow of the input member;
an angle between the portion of the input member and the portion of the shadow of the input member;
a velocity or acceleration of the input member; and
a velocity or acceleration of the shadow of the input member.

3. The method according to claim 1, wherein the contact range of the input pattern includes a direct contact of the input member to the input pattern.

4. The method according to claim 1, wherein the contact range of the input pattern includes positioning of the input member over the input pattern with a predetermined distance therebetween.

5. The method according to claim 1, wherein the input member includes a finger or a stylus, and the portion of the input member is an end of the input member.

6. The method according to claim 1, wherein the first determining step comprises:
correcting the captured image to convert the image into an inversely operated and normalized image; and
detecting a position of the converted and normalized image.

7. The method according to claim 1, wherein the first determining step comprises:
setting a shadow searching region; and
detecting position information of the portion of the shadow by analyzing the set shadow searching region.

8. A method for controlling an input unit including a light generation unit and a light receiving unit, the method comprising:
projecting an input pattern using the light generation unit;
receiving an image and a shadow of an input member over the input pattern using the light receiving unit;
selectively switching at least one of the light generation unit and the light receiving unit based on a mode of the input unit;
determining whether the input member falls in a contact range of the input pattern using information of the received image and shadow of the input member; and
performing an operation based on the determination result.

9. The method according to claim 8, wherein the information of the received image and shadow of the input member includes at least one of the following:
a distance between a portion of the input member and a portion of the shadow of the input member;
a distance between a point on the input pattern that corresponds to the portion of the input member, and the portion of the shadow of the input member;
an angle between the portion of the input member and the portion of the shadow of the input member;
a velocity or acceleration of the input member; and
a velocity or acceleration of the shadow of the input member.

10. The method according to claim 8, wherein the contact range of the input pattern includes a direct contact of the input member to the input pattern.

11. The method according to claim 8, wherein the contact range of the input pattern includes positioning of the input member over the input pattern with a predetermined distance therebetween.

12. The method according to claim 8, wherein the determining step comprises:
correcting the received image to convert the image into an inversely operated and normalized image; and
detecting a position of the converted and normalized image.

13. The method according to claim 8, wherein the determining step comprises:
setting a shadow searching region; and
detecting position information of a portion of the shadow by analyzing the set shadow searching region.

14. An input unit comprising:
a pattern generator configured to project an input pattern onto a surface;
an image receiver configured to capture an image of an input member over the input pattern; and
an image processor configured to first determine relationship information between a portion of the input member and a portion of a shadow of the input member using the captured image, and to second determine whether the input member falls in a contact range of the input pattern based on the relationship information,
whereby a command based on the second determination result can be executed.

15. An input unit comprising:
at least one light generation unit configured to project an input pattern onto a surface;
a light receiving unit configured to receive an image and a shadow of an input member over the input pattern;
a switch configured to selectively switch at least one of the light generation unit and the light receiving unit based on a mode of the input unit; and
an image processor configured to determine whether the input member falls in a contact range of the input pattern using information of the received image and shadow of the input member,
whereby an operation based on the determination result can be performed.

16. A mobile device comprising:
a wireless communication unit configured to perform wireless communication with a wireless communication system or another device;
an input unit configured to receive an input, and including
a pattern generator configured to project an input pattern onto a surface,
an image receiver configured to capture an image of an input member over the input pattern, and
an image processor configured to determine relationship information between a portion of the input member and a portion of a shadow of the input member using the captured image, to determine whether the input member falls in a contact range of the input pattern based on the relationship information, and to decide if the input is made based on these determinations;
a display unit configured to display information including the input received by the input unit; and
a storage unit configured to store the input pattern.

17. The mobile device according to claim 16, wherein the relationship information includes at least one of the following:
a distance between the portion of the input member and the portion of the shadow of the input member;
a distance between a point on the input pattern that corresponds to the portion of the input member, and the portion of the shadow of the input member;
an angle between the portion of the input member and the portion of the shadow of the input member;
a velocity or acceleration of the input member; and
a velocity or acceleration of the shadow of the input member.

18. The mobile device according to claim 16, wherein the contact range of the input pattern includes a direct contact of the input member to the input pattern.

19. The mobile device according to claim 16, wherein the contact range of the input pattern includes positioning of the input member over the input pattern with a predetermined distance therebetween.

20. The mobile device according to claim 16, wherein the input member includes a finger or a stylus, and the portion of the input member is an end of the input member.

21. The mobile device according to claim 16, wherein the image processor is configured to correct the captured image to convert the image into an inversely operated and normalized image, and to detect a position of the converted and normalized image.

22. The mobile device according to claim 16, wherein the image processor is configured set a shadow searching region, and to detect position information of the portion of the shadow by analyzing the set shadow searching region.

23. The mobile device according to claim 16, wherein the pattern generator comprises:
at least one light source configured to emit light; and
a filter including a pattern for generating the input pattern, and allowing the light from the lens to filter through so as to project an image of the input pattern onto the surface.
